(19) United States
(12) Patent Application Publication
(10) Pub. No.: US 2026/0197352 A1
(43) Pub. Date: Jul. 9, 2026

(54) HYBRID CONTENT SECURITY POLICY ENFORCEMENT FOR A WEB-BASED APPLICATION

(71) Applicant: Google LLC, Mountain View, CA (US)

(72) Inventor: Yesudeep Jose Mangalapilly, San Jose, CA (US)

(21) Appl. No.: 19/441,622

(22) Filed: Jan. 6, 2026

Related U.S. Application Data
(60) Provisional application No. 63/742,773, filed on Jan. 7, 2025.

(51) Int. Cl. H04L 9/40

(52) U.S. Cl. CPC H04L 63/20; H04L 63/145; H04L 63/30

(57) ABSTRACT

Methods and systems for hybrid content security policy (CSP) enforcement for a web-based application are provided herein. Data associated with a request directed to a web-based application is intercepted. A cryptographic value representing the intercepted data is obtained. A determination is made based on the cryptographic value of whether a CSP cache associated with the application stores a previously generated CSP value representing a CSP associated with an application resource pertaining to the request. Responsive to a determination that the CSP cache stores the previously generated CSP value, a response to the request is modified to include the previously generated CSP value. The modified response is forwarded to the client device associated with the request.

### RELATED APPLICATIONS

The present application claims the benefit under 35 U.S.C. § 119(e) of U.S. Provisional Patent Application No. 63/742,773 filed Jan. 7, 2025, which is incorporated by reference herein.

### TECHNICAL FIELD

Aspects and implementations of the present disclosure relate to hybrid content security policy enforcement for a web-based application.

### BACKGROUND

Modern web applications frequently utilize frameworks that render content both on the server and within the client browser. While this approach can enhance performance and user experience, it introduces significant security challenges. For example, cross-site scripting (XSS) vulnerabilities can allow malicious actors to inject scripts into web applications, potentially enabling the execution of untrusted code within the context of the application, which can compromise user data, session information, and the overall integrity of the web application. Content Security Policy (CSP) is a security mechanism used to mitigate XSS and other types of attacks, which allows web application developers to specify which resources can be loaded (e.g., by a browser) for a given page by adding appropriate headers (e.g., HTTP headers).

### SUMMARY

The below summary is a simplified summary of the disclosure in order to provide a basic understanding of some aspects of the disclosure. This summary is not an extensive overview of the disclosure. It is intended neither to identify key or critical elements of the disclosure, nor to delineate any scope of the particular implementations of the disclosure or any scope of the claims. Its sole purpose is to present some concepts of the disclosure in a simplified form as a prelude to the more detailed description that is presented later.

In some implementations, a method is disclosed for hybrid content security policy enforcement for a web-based application. The method includes intercepting data associated with a request directed to a web-based application. The method further includes obtaining a cryptographic value representing the intercepted data. The method further includes determining, based on the obtained cryptographic value, whether a content security policy (CSP) cache associated with the web-based application stores a previously generated CSP value representing a CSP associated with an application resource pertaining to the request. The method further includes, responsive to determining that the CSP cache stores the previously generated CSP value, modifying a response to the request to include the previously generated CSP value. The method further includes forwarding the modified response to a client device associated with the request.

In some implementations, the method further includes, responsive to determining that the CSP cache does not store the previously generated CSP value, generating a request token that is valid during a lifetime of the request. The method further includes modifying the response to the request to include the generated request token.

In some implementations, the method further includes identifying one or more application resources associated with the request. The method further includes modifying the response to further include integrity data associated with each of the one or more identified application resources.

In some implementations, the method further includes parsing the modified response to identify malicious data. The method further includes, responsive to identifying malicious data based on the parsing, performing one or more operations to remove the malicious data from the modified response.

In some implementations, the method further includes identifying one or more build files associated with the web-based application. The method further includes determining one or more application resources associated with the web-based application based on the identified one or more build files. The method further includes generating, for each respective application resource of the determined one or more application resources, at least one CSP value representing the CSP corresponding to the respective application resource. The method further includes updating the CSP cache to store the generated at least one CSP value, wherein updated CSP cache comprises the previously generated CSP value representing the CSP associated with the application resource pertaining to the request.

In some implementations, the method further includes generating integrity data for each of the determined one or more application resources associated with the web-based application, the integrity data indicating an initial state of the determined one or more application resources during a build time associated with the web-based application. The method further includes updating the identified one or more build files to include the generated integrity data.

In some implementations, the method further includes identifying, based on the generated integrity data, at least one application resource of the one or more application resources that satisfies a security threat criterion. The method further includes performing one or more threat neutralization operations to neutralize a security threat associated with the at least one application resource. The identified one or more build files are updated based on an output of the one or more threat neutralization operations.

In some implementations, the determined one or more application resources associated with the web-based application comprise at least one third-party resource.

In some implementations, the CSP cache is comprised in an immutable security manifest generated during a build time associated with the web-based application, the immutable security manifest further including metadata associated with one or more build files associated with the web-based application and integrity data generated for one or more application resources associated with the web-based application.

In some implementations, the cryptographic value representing the intercepted data comprises a cryptographic hash of at least one of content of the request or content of the response to the request.

### BRIEF DESCRIPTION OF DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example system architecture, in accordance with implementations of the present disclosure.

FIG. 2 is a block diagram that includes an example security engine, in accordance with implementations of the present disclosure.

FIG. 3 depicts a flow diagram of an example method for configuring a security manifest associated with a web-based application, in accordance with implementations of the present disclosure.

FIG. 4 depicts a flow diagram of an example method for hybrid content security policy enforcement for a web-based application, in accordance with implementations of the present disclosure.

FIG. 5 depicts an example of hybrid content security policy enforcement for a web-based application, in accordance with implementations of the present disclosure.

FIG. 6 is a block diagram illustrating an exemplary computer system, in accordance with implementations of the present disclosure.

### DETAILED DESCRIPTION

Aspects of the present disclosure relate to hybrid content security policy enforcement for a web-based application. Modern web applications frequently utilize frameworks that support features such as dynamically rendering partial component trees for the web application on the server and within the client browser. These frameworks, including those that implement client-side rendering, server-side rendering, static site generation, incremental static regeneration, and server components, allow developers to mix and match rendering strategies within a single application. Content Security Policy (CSP) is a browser security mechanism that helps mitigate cross-site scripting (XSS) and other types of attacks by allowing web application developers to specify which resources can be loaded for a given page through appropriate HTTP headers. A strict CSP utilizes cryptographic hashes and nonces as fingerprints to identify subresources, providing stronger protection compared to pattern-based allowlists. Hash-based CSPs are useful when the markup being rendered is largely static, while nonces are used with dynamically rendered content. Subresource integrity (SRI) is a related browser security feature that protects against potential risks of using externally hosted resources by using cryptographic hashes to verify that files loaded by the browser have not been tampered with or replaced with malicious versions.

Conventional implementations of strict CSP typically make use of nonces implemented as framework middleware or via templating systems. While this approach provides security benefits, it disables caching of static responses because each request generates a new nonce value that the browser treats as unique. Each request receives a new nonce value, causing the browser to treat every request as unique and preventing the browser from caching responses that would otherwise be cacheable. Most systems do not distinguish between static content that remains unchanged across requests and dynamic content that varies at runtime and therefore generally apply a uniform security policy mechanism regardless of content type, resulting in either reduced security when using weaker policies or reduced performance when using strict nonce-based policies. Additionally, conventional systems typically perform security policy generation entirely at runtime, which can introduce latency and computational overhead for each request.

The technical challenges associated with conventional CSP implementations lead to several negative impacts on web application performance and security. The inability to cache static responses leads to increased server load and network bandwidth consumption, as resources that could otherwise be served from cache are repeatedly fetched and processed. This inefficiency degrades user experience through slower page load times and increased latency. The runtime computation of security policies for every request consumes additional processing resources on the server, reducing the overall throughput and scalability of web applications. Furthermore, the lack of build-time integrity verification creates vulnerability windows where supply chain attacks could inject malicious content through third-party resources loaded from content delivery networks. When third-party resources are fetched at runtime without pre-computed integrity digests, attackers who compromise a content delivery network (CDN) can modify resources between the time an application is deployed and when users access it. The complexity of implementing strict CSP with existing approaches also increases the burden on developers, who may opt for weaker security configurations to avoid performance penalties, thereby reducing the overall security posture of web applications.

Embodiments of the present disclosure provide techniques for hybrid CSP enforcement for a web application. In some embodiments, a security engine can intercept data associated with a request directed to a web-based application and obtain a cryptographic value representing the intercepted data. The security engine can determine, based on the obtained cryptographic value, whether a CSP cache associated with the web-based application stores a previously generated CSP value representing a CSP associated with an application resource pertaining to the request. An application resource refers to any resource associated with a web-based application, including but not limited to scripts, stylesheets, images, fonts, or other subresources that may be inline, external, or third-party hosted. The CSP cache refers to a data structure that stores pre-computed CSP values (e.g., obtained during a build time associated with the application) indexed by content hashes or other cryptographic values and enabling efficient lookup at runtime to determine whether a response corresponds to static content known at build time. Build time refers to a phase in the application development lifecycle during which source code, markup files, and/or other application assets are compiled, bundled, optimized, and processed to produce development-ready artifacts prior to the application being deployed and made available to users.

Responsive to determining that the CSP cache stores the previously generated CSP value (e.g., indicating that the request is directed to static content of the application), the security engine can modify a response to the request to include the previously generated CSP value and forward the modified response to a client device associated with the request. Responsive to determining that the CSP cache does not store the previously generated CSP value (e.g., indicating that the request is directed to dynamic content of the application), the security engine can generate a token (e.g., a cryptographic random value such as a nonce) that is unique to the lifetime of the request (e.g., the duration of a single request-response cycle, beginning when a client device initiates a request directed to the application and ending when the corresponding response has been delivered to and processed by the client device) and is used to authorize execution of dynamically generated scripts and styles. The security engine can modify the request to include either the pre-generated CSP or the token, which, in some embodiments, can be used by a browser executing on a client device to verify the static and/or dynamic content relating to the request is as intended by a developer of the application and is not provided by or otherwise associated with a malicious actor. This hybrid approach enables the use of hash-based CSP values for static content while accommodating dynamic content through token generation, thereby preserving caching capabilities for static resources while maintaining security for dynamically rendered content.

The security engine includes an application bundler module that operates during a buildtime phase associated with the web-based application, as indicated above. The application bundler module identifies one or more build files associated with the web-based application and determines one or more resources associated with the web-based application based on the identified build files. A build file refers to an output artifact generated by a framework bundler, including but not limited to HyperText Markup Language (HTML) files, JavaScript files, Cascading Style Sheets (CSS) stylesheets, and/or other static assets produced during a build process associated with the web-based application. For each respective resource, the application bundler module generates at least one CSP value representing the CSP corresponding to the respective resource. The CSP cache is updated to store the generated CSP values, creating an immutable security manifest that can be consumed at runtime. The application bundler module also generates integrity data for each of the determined resources, where the integrity data indicates an initial state of the resources during buildtime. This integrity data includes subresource integrity digests (e.g., a subresource integrity (SRI) digest including cryptographic values that enable browsers to verify that fetched resources have not been tampered with or replaced with malicious versions) that are injected back into the markup, enabling browsers to verify that fetched resources have not been tampered with. The build files are updated to include the generated integrity data, and the bundler may also fetch third-party subresources to avoid supply chain attacks at runtime by ensuring that external resources are captured and verified during the build process rather than being fetched from potentially compromised CDNs at request time.

The security engine further includes an interceptor module that operates during runtime to intercept traffic to and from an upstream application. When a request is received from a client device and/or a response is received from the upstream application, the interceptor module computes a cryptographic hash of the response content and uses this hash to query the CSP cache. The cryptographic value representing the intercepted data may include a cryptographic hash of at least one of content of the request or content of the response to the request. If the hash matches an entry in the CSP cache, indicating a cache hit for static content, the interceptor module retrieves the pre-computed CSP value and attaches it to the response. If no match is found, indicating dynamic content or content not known at build time, the interceptor module generates a nonce token through a token generator module and injects this nonce into the response along with any applicable integrity digests. A response modifier module then produces the modified response containing the appropriate security policy information before forwarding it to the client device.

The security manifest generated during buildtime includes metadata associated with the build files, CSP entries containing content hashes and associated CSP hash values, and entries for inline subresources and third-party resources. The manifest may also include bundle options that were used to produce it, facilitating review processes and auditing. The manifest identifier may be computed as a root hash of a hash tree of asset hashes, providing a single cryptographic fingerprint that uniquely represents the integrity of all underlying assets known at build time. The security engine may also perform sanitization operations on markup to identify and remove potentially malicious content, and may identify resources that satisfy a security threat criterion (e.g., exhibits patterns or characteristics associated with known attack vectors, such as malicious content in scalable vector graphics (SVGs), images, inline event handlers, or other markup structures that could be exploited by attackers at runtime) and perform threat neutralization operations to neutralize associated security threats before updating the build files based on the output of these operations.

Implementations of the present disclosure address the above and other deficiencies of conventional systems by providing a hybrid approach that enables caching of static responses while maintaining strict CSP enforcement. By pre-computing CSP values and integrity digests at build time, the system reduces runtime computational overhead and improves response latency for static content. The ability to cache static responses reduces server load and bandwidth consumption, improving scalability and reducing operational costs. Users experience faster page load times as browsers can cache and reuse static resources that have been verified through hash-based CSP. The build-time fetching and verification of third-party resources mitigates supply chain attack vectors by ensuring that external resources are captured in a known-good state during deployment. The immutable security manifest provides a trusted source of security policy information that can be efficiently queried at runtime without requiring complex policy generation for each request. The hybrid approach allows developers to implement strict CSP without sacrificing performance, encouraging adoption of stronger security configurations and improving the overall security posture of web applications.

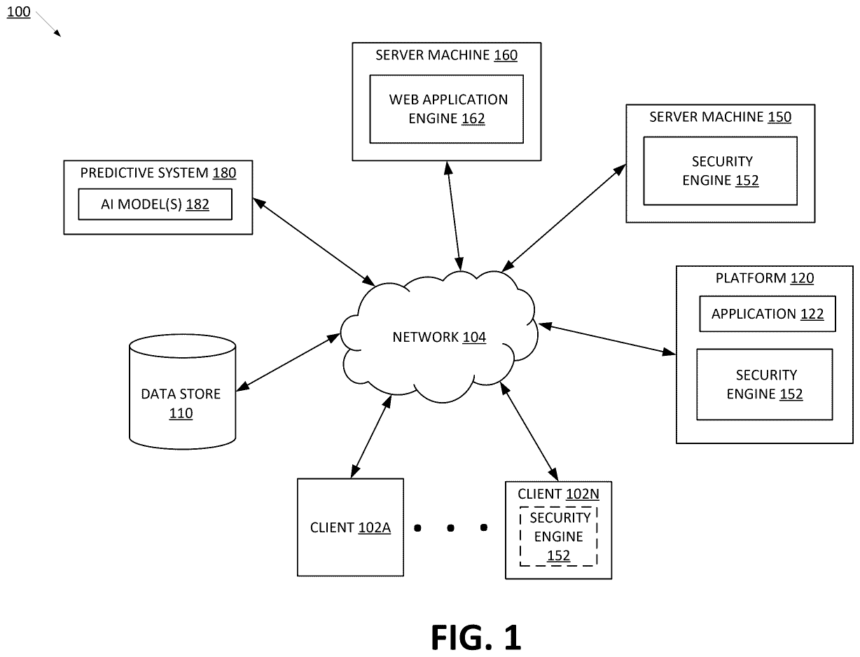

FIG. 1 illustrates an example system architecture 100, in accordance with implementations of the present disclosure. The system architecture 100 (also referred to as “system” herein) includes client devices 102A-N (collectively and individually referred to as client device 102 herein), a data store 110, a platform 120, server machine 150, and/or a predictive system 180 each connected to a network 104. In some embodiments, system 100 can additionally or alternatively include one or more nodes 160 that host or otherwise support agents 162 associated with predictive system 180. In implementations, network 104 can include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof. In some embodiments, system 100 can be or otherwise include a cloud-based computing environment (also referred to as a “cloud-based environment” herein).

In some implementations, data store 110 is a persistent storage that is capable of storing data as well as data structures to tag, organize, and index the data. Data store 110 can be hosted by one or more storage devices, such as main memory, magnetic or optical storage based disks, tapes or hard drives, NAS, SAN, and so forth. In some implementations, data store 110 can be a network-attached file server, while in other embodiments data store 110 can be some other type of persistent storage such as an object-oriented database, a relational database, and so forth, that may be hosted by platform 120 or one or more different machines coupled to the platform 120 via network 104.

As illustrated by FIG. 1, system 100 can include one or more client devices 102. A client device 102 refers to a computing device that includes hardware components configured to communicate with other devices and systems over network 104. In some embodiments, a client device 102 may include a processing unit, memory, input/output interfaces, and network communication hardware that enable the device to send and receive data. The client device 102 may be implemented as various types of computing hardware, such as a desktop computer, laptop computer, tablet device, smartphone, or other electronic device with network connectivity capabilities. In some cases, the client device 102 may include or be otherwise connected to a display screen, user input mechanisms such as keyboards or touchscreens, and data storage components.

Platform 120 may be configured to host and serve web-based applications to client devices 102 over network 104. In some embodiments, platform 120 can include an application 122 that represents a web-based application (also referred to herein as a web application) built using frameworks that support features such as client-side rendering, server-side rendering, static site generation, incremental static regeneration, and server components. These frameworks allow developers to mix and match rendering strategies within a single application, where some content remains static across requests while other content is dynamically generated at runtime. The application 122 may generate markup that is served to client devices 102 in response to requests directed to the web-based application 122.

As illustrated by FIG. 1, system 100 can include a web-based application engine 162 that is configured to handle operations related to web-based applications 122 hosted on platform 120. The web-based application engine 162 processes requests from client devices 102, coordinates with application 122 to generate appropriate responses, and manages the delivery of web content including markup, scripts, stylesheets, and other resources. A client device 102 can access the application 122 by sending requests over network 104 to platform 120, where the web-based application engine 162 receives and processes these requests to generate responses containing the requested web content.

As further illustrated by FIG. 1, platform 120 can include a security engine 152 that is configured to provide hybrid content security policy (CSP) enforcement for the web-based application 122. The security engine 152 implements a hybrid approach that enables the use of hash-based CSP values for static content while accommodating dynamic content through token generation. This hybrid approach preserves caching capabilities for static resources while maintaining security for dynamically rendered content. The security engine 152 intercepts data associated with requests directed to the web-based application 122, obtains cryptographic values representing the intercepted data, and determines whether a CSP cache stores previously generated CSP values for application resources pertaining to the requests.

In some embodiments, the security engine 152 operates during both a buildtime phase and a runtime phase associated with the web-based application 122. During the buildtime phase, the security engine 152 identifies build files associated with the web-based application, determines resources associated with the web-based application based on the identified build files, generates CSP values for each resource, and updates a CSP cache to store the generated CSP values. The security engine 152 also generates integrity data for each resource, where the integrity data indicates an initial state of the resources during buildtime. This integrity data includes subresource integrity digests that are injected back into the markup, enabling browsers to verify that fetched resources have not been tampered with. The security engine 152 may also fetch third-party subresources during buildtime to avoid supply chain attacks at runtime by ensuring that external resources are captured and verified during the build process rather than being fetched from potentially compromised content delivery networks at request time.

During the runtime phase, the security engine 152 intercepts traffic to and from the application 122. When a response is received from the application 122, the security engine 152 computes a cryptographic hash of the response content and uses this hash to query the CSP cache. If the hash matches an entry in the CSP cache, indicating a cache hit for static content, the security engine 152 retrieves the pre-computed CSP value and attaches it to the response. If no match is found, indicating dynamic content or content not known at build time, the security engine 152 generates a nonce token and injects this nonce into the response along with any applicable integrity digests. The security engine 152 then produces a modified response containing the appropriate security policy information before forwarding it to the client device 102.

In some embodiments, the security engine 152 generates an immutable security manifest during the buildtime phase that can be consumed at runtime. The security manifest includes metadata associated with the build files, CSP entries containing content hashes and associated CSP hash values, and entries for inline subresources and third-party resources. The manifest may also include bundle options that were used to produce it, facilitating review processes and auditing. The security engine 152 may also perform sanitization operations on markup to identify and remove potentially malicious content, and may identify resources that satisfy a security threat criterion and perform threat neutralization operations to neutralize associated security threats before updating the build files based on the output of these operations. In some embodiments, security engine 152 can perform one or more operations based on outputs of an artificial intelligence (AI) model 182 of or otherwise associated with predictive system 180.

It should be noted that although FIG. 1 illustrates security engine 152 as part of platform 120, in additional or alternative embodiments, security engine 152 can reside on one or more server machines that are remote from platform 120. For example, security engine 152 can reside at server machine 150. In other or similar embodiments, security engine 152 can reside on one or more client devices 102. Further, although FIG. 1 illustrates predictive system 180 as remote from platform 120, in additional or alternative embodiments, predictive system 180 can reside on platform 120, server machine(s) 150, 160, client device 102, node(s) 160, and/or any other component of system 100. It should be noted that in some other implementations, the functions of client device(s) 102, platform 120, server machines 150, 160, and/or predictive system(s) 180 can be provided by more or a fewer number of machines. For example, in some implementations, components and/or modules of client device(s) 102, platform 120, server machines 150, 160, and/or predictive system(s) 180 may be integrated into a single machine, while in other implementations components and/or modules of any of client device(s) 102, platform 120, server machines 150, 160, and/or predictive system(s) 180 may be integrated into multiple machines. In addition, in some implementations, components and/or modules of server machines 150, 160, and/or predictive system(s) 180 into platform 120.

In general, functions described in implementations as being performed platform 120, server machines 150, 160, and/or predictive system(s) 180 can also be performed on the client device 102 in other implementations. In addition, the functionality attributed to a particular component can be performed by different or multiple components operating together. Platform 120 can also be accessed as a service provided to other systems or devices through appropriate application programming interfaces, and thus is not limited to use in websites.

In implementations of the disclosure, a “user” can be represented as a single individual. However, other implementations of the disclosure encompass a “user” being an entity controlled by a set of users and/or an automated source. For example, a set of individual users federated as a community in a social network can be considered a “user.” Further to the descriptions above, a user may be provided with controls allowing the user to make an election as to both if and when systems, programs, or features described herein may enable collection of user information (e.g., information about a user's social network, social actions, or activities, profession, a user's preferences, or a user's current location), and if the user is sent content or communications from a server. In addition, certain data can be treated in one or more ways before it is stored or used, so that personally identifiable information is removed. For example, a user's identity can be treated so that no personally identifiable information can be determined for the user, or a user's geographic location can be generalized where location information is obtained (such as to a city, ZIP code, or state level), so that a particular location of a user cannot be determined. Thus, the user can have control over what information is collected about the user, how that information is used, and what information is provided to the user.

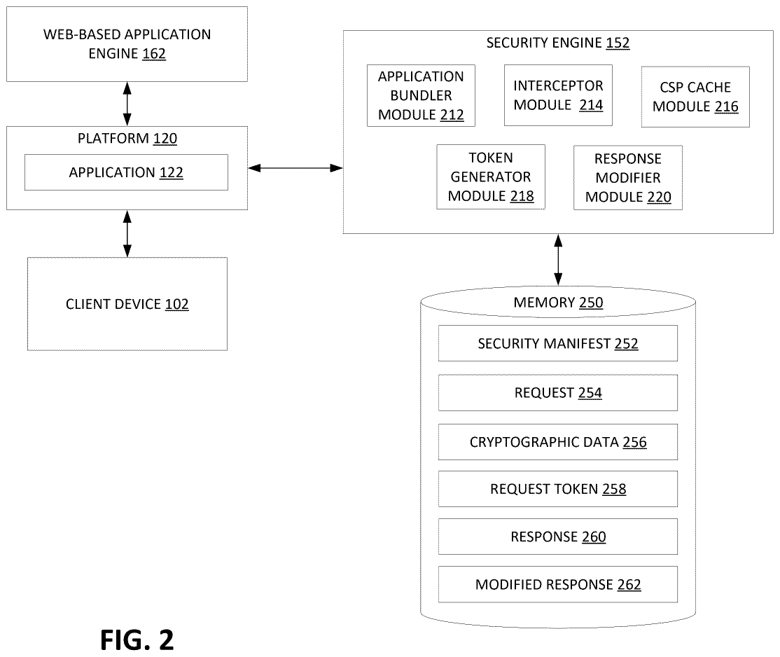

FIG. 2 is a block diagram that includes an example platform 120 and an example security engine 152, in accordance with implementations of the present disclosure. As described above, security engine 152 can reside at or can otherwise be connected to platform 120 (e.g., using network 104). In some embodiments, platform 120 and/or security engine 152 can be connected to memory 250. Memory 250 can correspond to one or more portions of data store 110, in some embodiments. In additional or alternative embodiments, memory 250 can correspond to any memory of, connected to, or accessible by a component of system 100.

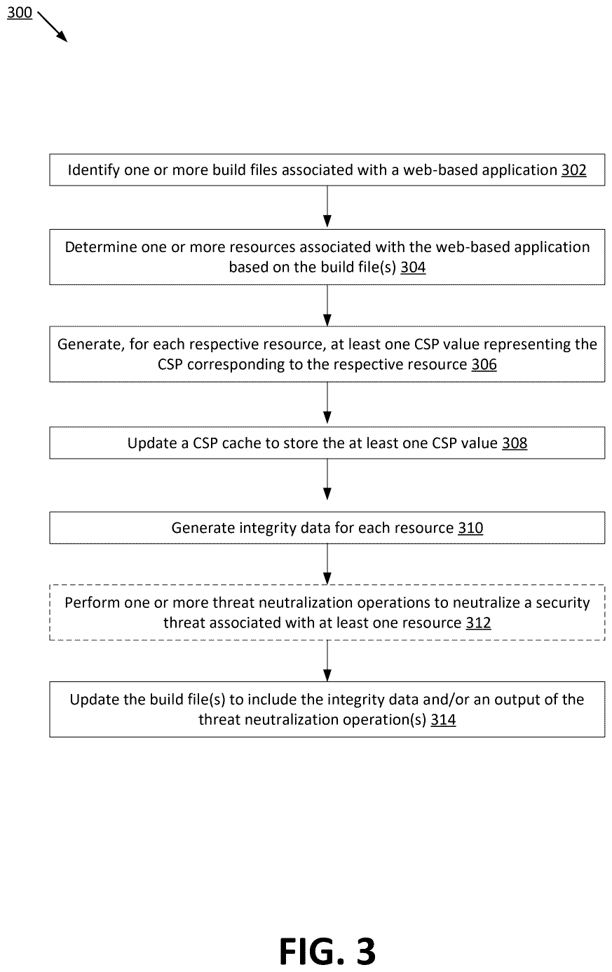

As described above, security engine 152 can be configured to provide hybrid content security policy (CSP) enforcement for the web-based application 122. As illustrated in FIG. 2, security engine 152 can include an application bundler module 212, an interceptor module 214, a CSP cache module 216, a token generator module 218, and/or a response modifier module 220. Embodiments pertaining to security engine 152 are described, at least, with respect to FIGS. 3-5 below.

FIG. 3 depicts a flow diagram of an example method 300 for configuring a security manifest associated with a web-based application, in accordance with implementations of the present disclosure. Method 300 can be performed by processing logic that can include hardware (circuitry, dedicated logic, etc.), software (e.g., instructions run on a processing device), or a combination thereof. In some embodiments, some or all of the operations of method 300 can be performed by one or more components of system 100 of FIG. 1. For example, some or all of the operations of method 300 can be performed by security engine 152, as described above.

At block 302, processing logic identifies one or more build files associated with a web-based application. The build files can include markup files generated by application tooling, such as bundlers that compile and optimize frontend code for deployment. In some embodiments, the build files include HTML files, JavaScript files, CSS stylesheets, and other static assets produced during a build process associated with the web-based application. Application bundler module 212 may scan directories containing the build files to identify markup that involves processing for security policy generation.

In some embodiments, identifying the build files includes reading output artifacts generated by a framework bundler, where the framework bundler produces the web-based application and the processing logic operates as a re-bundler that takes the output of the framework bundler and processes it for security purposes. As used herein, the term “framework bundler” or simply “bundler” refers to a build tool (e.g., software, hardware, a combination of software and hardware, etc.) that compiles, optimizes, and packages frontend code associated with a web-based application 122 to produce output artifacts ready for deployment. A framework bundler may process source code files, including JavaScript, TypeScript, CSS, and markup files, and generate bundled output files that are optimized for delivery to client devices. Examples of framework bundlers include tools that support modern web application frameworks capable of client-side rendering, server-side rendering, static site generation, incremental static regeneration, and server components. The framework bundler produces build artifacts that may include HTML files, JavaScript bundles, CSS stylesheets, and other static assets.

The build files may include files associated with various rendering modes supported by modern frameworks, including static site generation artifacts, server-side rendering templates, and client-side rendering scripts. Some frameworks can render stateful component trees on both the server and within the web browser, and in order to synchronize changes in state, these frameworks leverage several kinds of rendering modes. Client-side rendering (CSR) involves rendering the full component tree within the web browser at runtime using DOM patching, which provides efficient user interfaces for RPC/REST operations but may result in slower initial load times and search engine optimization challenges. Server-side rendering (SSR) involves rendering the full component tree on the server at request time using templates or simulated DOM, which provides efficient latency management but may increase server load and result in slower interactivity. Static site generation (SSG) involves pre-rendering the entire application or website at build time into static HTML, which provides efficient latency and cache management but involves rebuilds for content updates and is not ideal for dynamic content. Incremental static regeneration (ISR) involves regenerating static HTML on the server at regular intervals to update it with fresh data, which provides efficient latency and cache invalidation management but may introduce delays in updates and complexity in setup. Server components, such as React server components (RSC), involve rendering partial component trees or individual components on the server at request time and streaming DOM patches to the client, which provides efficient partial state transfer but involves a server environment and is not fully client-side. Such frameworks allow developers to mix and match any combination of these rendering modes within a single application, and the combined use of the application bundler module 212 and the interceptor module 214 works to handle any combination of these rendering modes by generating appropriate CSP values and integrity data during buildtime and applying the appropriate security policy mechanism at runtime based on whether the content is static or dynamic, as described in further detail below.

At block 304, processing logic determines one or more resources associated with the web-based application based on the build file(s). The resources can include various types of subresources that are referenced by or embedded within the markup files. In some embodiments, determining the resources includes parsing the markup to identify script elements, stylesheet links, image references, and other embedded content. The resources may include inline subresources, which are scripts or styles embedded directly within the markup, as well as external subresources that are referenced by URL. Application bundler module 212 may extract inline subresources from the markup for separate processing and integrity digest calculation.

In some embodiments, the resources include third-party subresources that are hosted on external content delivery networks (CDNs) or other external servers. Third-party subresources present particular security concerns because the content of these resources can change at runtime, potentially enabling supply chain attacks where an attacker compromises the CDN and modifies the resource to inject malicious code. To mitigate this risk, application bundler module 212 may fetch third-party subresources during the buildtime phase by identifying indicators (e.g., uniform resource locators (URLs) within the build files referencing external content delivery networks or other external servers within the markup, issuing network requests to retrieve the resources from those external locations, and storing local copies of the fetched resources (e.g., at memory 250). The locally stored copies of third-party subresources can be served directly from the application's infrastructure, eliminating runtime dependencies on external servers and ensuring that the integrity digests computed during buildtime remain valid. In some embodiments, the application bundler module 212 updates references in the markup to point to the locally stored copies rather than the original external URLs, and injects subresource integrity attributes into the corresponding script or link tags to enable browser-side verification that the fetched resources match the expected content.

The resources may also include various types of elements that can be loaded using script tags and link tags. Script tags can be used to load JavaScript code, JavaScript modules, JSON data, and WebAssembly binary code, among other resource types. Link tags can be used to load stylesheets, favicons, preloaded resources, module preloads, web app manifests, and platform-specific icons. For each identified resource, application bundler module 212 determines the resource type, content type, URL or path, and any dependencies or relationships with other resources. The determined resources are used to build a dependency graph that identifies which resources are children or descendants of other resources, enabling the generation of appropriate CSP entries that account for the relationships between resources.

At block 306, processing logic generates, for each respective resource, at least one CSP value representing the CSP corresponding to the respective resource. The CSP value can include a cryptographic hash that serves as a fingerprint to identify the resource for purposes of content security policy enforcement. In some embodiments, application bundler module 212 calculates integrity digests for each resource using cryptographic hash functions specified by web standards, such as SHA-256, SHA-384, or SHA-512. The choice of hash algorithm may be configured at build time based on deployment architecture and constraints, and the set of allowed hashing algorithms may be expanded as web standards evolve.

For each resource, the CSP value generation process involves computing a hash of the resource content and encoding the hash in a format suitable for inclusion in a CSP HTTP header. The CSP hash format can include an algorithm identifier prefix followed by a base64-encoded digest value, such as ‘sha256-[base64-encoded-hash]’. In some embodiments, application bundler module 212 generates CSP hash entries that include the directive to which the hash applies (e.g., script-src, style-src), the hash value itself, references to the resources associated with the hash, and the URL or path of the resource.

For markup files such as HTML documents, application bundler module 212 may generate a CSP entry that includes a content hash representing the hash of the document itself, a flag indicating whether strict-dynamic should be enabled for the document, and an array of CSP hash entries for all subresources that the document references or contains. The CSP entry may also include the path of the document to enable lookup based on request URL during runtime. For inline subresources such as inline scripts or inline styles embedded directly within markup, application bundler module 212 extracts the inline content, computes the hash of the extracted content, and generates a corresponding CSP hash entry. The inline content may optionally be extracted to separate files, with the markup updated to reference the extracted files, depending on configuration options.

In some embodiments, application bundler module 212 determines dependencies between resources and generates CSP entries that account for these relationships. For each document, the application bundler module 212 may identify child resources that are directly referenced by the document and descendant resources that are transitively referenced through the dependency chain. Child resources include subresources that are explicitly referenced within the document's markup, such as script elements with src attributes pointing to JavaScript files, link elements referencing stylesheets, and image elements referencing image files. Descendant resources encompass the transitive closure of all resources reachable from the document through its dependency graph, including resources referenced by child resources and resources referenced by those resources in turn. For example, if a document references a JavaScript file that in turn imports additional JavaScript modules, the directly referenced JavaScript file is a child resource while both the directly referenced file and the imported modules are descendant resources. The application bundler module 212 traverses the dependency graph starting from each document to enumerate all descendant resources, recording the relationships in the manifest entries. Each entry in the manifest may include a children array listing the paths or identifiers of directly referenced child resources and a descendants array listing all transitively referenced descendant resources. Additionally, each entry may include a descendantsCspHashes array that aggregates the CSP hash values for all descendant resources, enabling the generation of a complete CSP header that authorizes execution of the entire dependency tree without requiring runtime traversal of the dependency graph. The CSP entry for a document may include an array of descendant CSP hashes that encompasses all hashes needed to authorize execution of the document and its dependencies. This enables the generation of a complete CSP header that authorizes all resources needed to render a page without runtime computation of the dependency graph.

At block 308, processing logic updates a CSP cache to store the at least one CSP value. The CSP cache serves as an immutable database that maps content hashes to their corresponding CSP entries, enabling efficient lookup during runtime. In some embodiments, application bundler module 212 stores the generated CSP values in a data structure that associates each document's content hash with the complete set of CSP hash entries needed to authorize execution of that document and its dependencies. The CSP cache may be organized to support lookup by content hash, enabling the interceptor module 214 to quickly determine whether a response from the upstream application corresponds to a known static resource.

In some embodiments, the CSP cache is comprised within a security manifest 252 that is generated during the buildtime phase. The security manifest 252 serves as a comprehensive record of all assets known at build time and their associated security policy information. The security manifest 252 may include multiple categories of entries, including entries for markup documents, entries for inline subresources that were extracted from markup, and entries for third-party subresources that were fetched from external sources. Each entry in the security manifest 252 may include fields such as the algorithm used for hashing, the base64-encoded digest value, the basename of the file, the content type, the CSP hash in the format expected by browsers, the raw digest bytes, the node type indicating the kind of resource, the path to the resource, the subresource integrity string, the URL of the resource, and arrays identifying child and descendant resources along with their CSP hashes.

The security manifest 252 may also include metadata about the manifest itself, such as a manifest identifier, a timestamp indicating when the manifest was generated, and a URL prefix for the application. The manifest identifier may be computed as a root hash of a hash tree (also known as a Merkle tree) of asset hashes, providing a single cryptographic fingerprint that uniquely represents the integrity of all underlying assets known at build time. In a hash tree structure, individual asset hashes form the leaf nodes, and parent nodes are computed by concatenating and hashing their child nodes, with the process continuing recursively until a single root hash is obtained. This structure enables efficient verification of manifest integrity and detection of any modifications to the underlying assets.

In some embodiments, the security manifest 252 includes bundle options that record the configuration settings used during the buildtime phase. The bundle options may include settings such as the hash algorithm used, a bundle identifier, a commit hash from version control, cross-origin settings, flags indicating whether sanitization is enabled, flags indicating whether inline content should be extracted, flags indicating whether external subresources should be fetched, the manifest format, directory paths for markup and static files, URL prefixes, and flags controlling extraction of specific types of inline content such as scripts, styles, style attributes, and images. Recording the bundle options in the manifest facilitates review processes and auditing by enabling administrators to determine the exact configuration that produced a given manifest, which can be useful for root cause analysis when security issues are identified.

The CSP cache and security manifest 252 are treated as immutable after generation, meaning that the contents are not modified during runtime operation. This immutability property enables the interceptor module 214 to operate in a relatively thread-safe manner, as multiple concurrent requests can read from the CSP cache without risk of data races or inconsistent state. When a new version of the web-based application 122 is deployed, a new security manifest is generated during the buildtime phase, and the interceptor module 214 is configured to use the new manifest. In some embodiments, the security manifest is communicated between the application bundler module 212 and the interceptor module 214 through a trusted channel to prevent tampering with the security policy information.

At block 310, processing logic generates integrity data for each resource. The integrity data includes subresource integrity (SRI) digests that enable browsers to verify that fetched resources have not been tampered with or replaced with malicious versions. Subresource integrity is a browser security feature that protects against potential risks of using externally hosted resources, particularly those loaded from content delivery networks, by using cryptographic hashes to ensure the files the browser loads match the expected content.

In some embodiments, application bundler module 212 generates integrity data by computing cryptographic hashes of each resource's content using hash algorithms specified by web standards, such as SHA-256, SHA-384, or SHA-512. The integrity data is formatted as a subresource integrity string that includes an algorithm identifier followed by a base64-encoded digest value, such as ‘sha384-[base64-encoded-hash]’. For resources that may be loaded using script tags or link tags, the integrity data is formatted for inclusion in an integrity attribute that can be added to the corresponding HTML element.

For example, a script tag with subresource integrity specified using the integrity attribute may have a specific form. When a browser encounters such a tag, it fetches the resource from the specified URL, computes the hash of the fetched content, and compares the computed hash against the hash specified in the integrity attribute. If the hashes match, the browser executes or applies the resource; if the hashes do not match, the browser refuses to execute or apply the resource and may report a security violation.

In some embodiments, application bundler module 212 generates integrity data for various types of resources including JavaScript files, JavaScript modules, CSS stylesheets, images, and other static assets. The integrity data may be stored in the security manifest 252 as part of each resource entry, with fields including the algorithm used for hashing, the base64-encoded digest value, and the complete subresource integrity string formatted for injection into markup. The integrity data enables the interceptor module 214 to inject integrity attributes into responses at runtime for dynamic content, ensuring that even dynamically generated markup includes appropriate integrity verification for referenced resources.

At block 312, processing logic optionally performs one or more threat neutralization operations to neutralize a security threat associated with at least one resource. In some embodiments, application bundler module 212 identifies resources that satisfy a security threat criterion based on analysis of the resource content, resource type, resource origin, or other characteristics that indicate potential security risks. The security threat criterion may include patterns associated with known attack vectors, such as inline event handlers, javascript: URLs, data: URLs containing executable content, or markup structures that could enable script injection.

In some embodiments, the threat neutralization operations include sanitization operations that identify and remove potentially malicious content from markup. Sanitization may involve parsing the markup to identify elements, attributes, or content patterns that could be exploited by attackers, and either removing the identified elements entirely or modifying them to neutralize the associated threat. For example, sanitization operations may remove inline event handler attributes such as onclick, onload, or onerror that could be used to execute arbitrary JavaScript code. Sanitization operations may also remove or neutralize potentially dangerous elements within SVG images, which can contain embedded scripts or event handlers that execute when the image is rendered.

In some embodiments, the threat neutralization operations include extraction operations that move inline content to separate files where it can be more securely managed. For example, inline scripts embedded within HTML markup may be extracted to separate JavaScript files, with the original inline script element replaced by a script element with a src attribute referencing the extracted file. This extraction enables the application of stricter CSP directives that prohibit inline script execution while still allowing the extracted scripts to execute when authorized by hash-based or nonce-based CSP entries. Similarly, inline styles may be extracted to separate CSS files, and inline style attributes on individual elements may be extracted and consolidated into stylesheet rules.

In some embodiments, the threat neutralization operations include validation operations that verify resources conform to expected formats and do not contain unexpected or potentially malicious content. Validation may involve parsing resources according to their declared content type and verifying that the parsed structure matches expected patterns. For example, validation of JavaScript files may verify that the content parses as valid JavaScript without syntax errors that could indicate injection attempts. Validation of JSON data may verify that the content parses as valid JSON and does not contain unexpected fields or values.

The output of the threat neutralization operations may include sanitized versions of the original resources, extracted files containing content that was removed from the original resources, and metadata indicating what modifications were made and why. This output is used to update the build files at block 314, ensuring that the deployed application includes the sanitized and validated resources rather than the original potentially vulnerable versions.

At block 314, processing logic updates the build file(s) to include the integrity data and/or an output of the threat neutralization operation(s). In some embodiments, application bundler module 212 modifies the original markup files to inject subresource integrity attributes into script tags, link tags, and other elements that reference external or extracted resources. For each script element with a src attribute, the application bundler module 212 adds an integrity attribute containing the subresource integrity string computed for the referenced JavaScript file, along with a crossorigin attribute set to an appropriate value such as “anonymous” to enable integrity checking for cross-origin resources. Similarly, for each link element referencing a stylesheet or other resource type that supports integrity checking, the application bundler module 212 injects the corresponding integrity attribute.

In some embodiments, updating the build files includes replacing inline content with references to extracted files. When inline scripts have been extracted to separate JavaScript files during threat neutralization operations, the application bundler module 212 replaces the original inline script element containing the script content with a script element having a src attribute pointing to the extracted file and an integrity attribute containing the hash of the extracted content. This replacement ensures that the deployed markup references the extracted files rather than containing inline content that would involve less restrictive CSP directives.

In some embodiments, updating the build files includes modifying references to third-party resources to point to locally cached copies. When third-party subresources have been fetched and stored locally during the buildtime phase, the application bundler module 212 updates the URLs in the markup to reference the local copies rather than the original external URLs. This modification ensures that the deployed application serves third-party resources from its own infrastructure, eliminating runtime dependencies on external content delivery networks and ensuring that the integrity digests computed during buildtime remain valid throughout the application's deployment lifecycle.

In some embodiments, updating the build files includes writing sanitized versions of markup files to an output directory. The sanitized markup includes all modifications made during the buildtime phase, including injected integrity attributes, replaced inline content, updated third-party resource references, and removed or neutralized potentially malicious elements. The output directory may be separate from the original build file directory, preserving the original files for reference while producing a set of deployment-ready files that incorporate all security enhancements.

In some embodiments, application bundler module 212 generates output files in addition to the modified markup, including the security manifest 252 containing the CSP cache and all associated metadata. The security manifest 252 may be written in a structured format such as JSON that can be efficiently parsed by the interceptor module 214 at runtime. The output may also include extracted inline content files, locally cached third-party resources, and log files documenting the modifications made during the buildtime phase. The complete set of output files constitutes the deployment artifacts that are uploaded to the web server or content delivery network for serving to client devices 102.

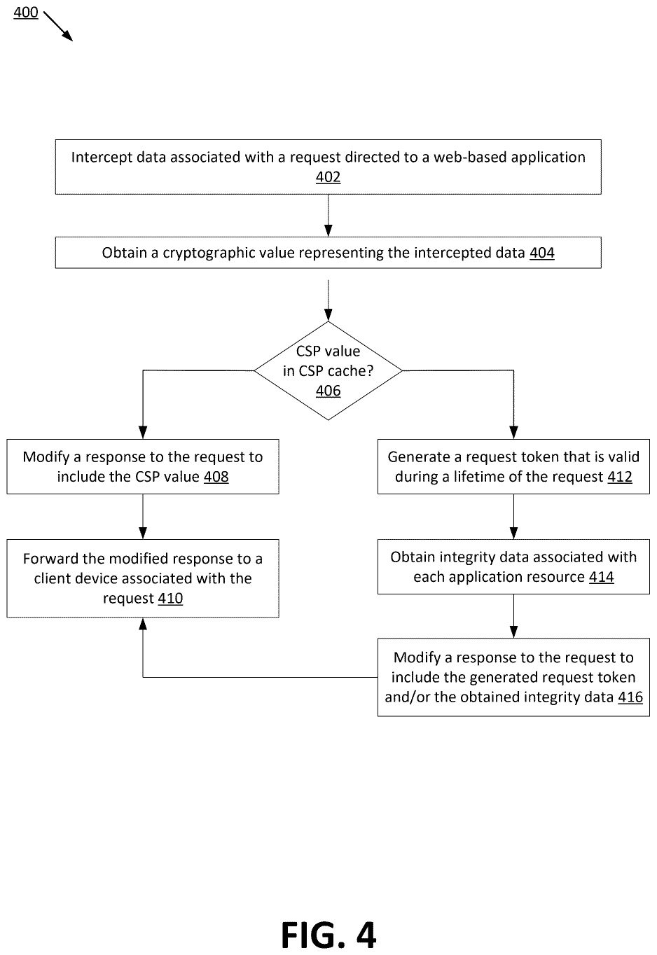

FIG. 4 depicts a flow diagram of an example method 400 for hybrid content security policy enforcement for a web-based application, in accordance with implementations of the present disclosure. Method 400 can be performed by processing logic that can include hardware (circuitry, dedicated logic, etc.), software (e.g., instructions run on a processing device), or a combination thereof. In some embodiments, some or all of the operations of method 300 can be performed by one or more components of system 100 of FIG. 1. For example, some or all of the operations of method 300 can be performed by security engine 152, as described above.

At block 402, processing logic intercepts data associated with a request directed to a web-based application. In some embodiments, interceptor module 214 operates as a reverse proxy that receives incoming requests from client devices 102 before the requests reach the upstream application 122. The interceptor module 214 monitors for incoming network traffic on a port of a network device associated with platform 120 that is designated for application 122 and acts as an intermediary between the client device 102 and the application 122. A port refers to a logical or physical endpoint for network communication via a network device (e.g., a switch, a network interface card (NIC), etc.) identified by a numerical value or identifier in accordance with network protocols. Interceptor module 214 may monitor the port designated for application 122 by establishing a network socket bound to that port and waiting for incoming network traffic, which may include HTTP requests, When a request arrives at the interceptor module 214, the interceptor module 214 captures the request data, which may include HTTP headers, request method, request path, query parameters, and request body content.

In some embodiments, the interceptor module 214 intercepts both the incoming request and the corresponding response from the upstream application 122. The interceptor module 214 forwards the incoming request to the application 122 after performing filtering or validation operations, in some embodiments. The filtering operations may include evaluating fetch metadata headers to assess the security context of the request (e.g., information that characterizes the circumstances under which the network request was initiated, such as the origin of the request, the mode or purpose of the request, whether the request was triggered by user activation, the intended destination or resource type of the request, and so forth) before permitting it to reach the upstream application. Fetch metadata headers are request headers that provide information about the context from which a request was initiated, enabling the server to make informed decisions about whether to process the request. The Sec-Fetch-Site header may indicate the relationship between the origin that initiated the request and the origin of the requested resource, with possible values including “same-origin” for requests where both origins are identical, “same-site” for requests between origins that share the same registrable domain, “cross-site” for requests between unrelated origins, and “none” for requests initiated directly by user action such as entering a URL in the address bar. The Sec-Fetch-Mode header may indicates the mode of the request, such as “navigate” for top-level navigation requests, “cors” for cross-origin resource sharing requests, “no-cors” for simple cross-origin requests, and “same-origin” for same-origin requests. The Sec-Fetch-User header indicates whether the request was triggered by user activation, with a value of “?1” indicating user-initiated requests. The Sec-Fetch-Dest header may indicates the intended destination of the request, such as “document” for navigation requests, “script” for script requests, “style” for stylesheet requests, “image” for image requests, and other values corresponding to different resource types.

The interceptor module 214 evaluates these fetch metadata headers against configured security policies to determine whether the request should be forwarded to the application 122 or denied. For example, the interceptor module 214 may be configured to deny cross-site requests that target sensitive endpoints, preventing cross-site request forgery attacks where a malicious website attempts to perform actions on behalf of an authenticated user. Requests that fail the metadata evaluation may be rejected with an appropriate error response, such as an HTTP 403 Forbidden status, without the request ever reaching the application 122. Requests that pass the metadata evaluation are forwarded to the application 122 for processing, with the interceptor module 214 maintaining state information to correlate the forwarded request with the subsequent response for security policy application.

When the application 122 generates a response, the interceptor module 214 intercepts the response before it is transmitted to the client device 102. The intercepted data associated with the request may therefore include the response content generated by the application 122, response headers, and response status information. This bidirectional interception enables the interceptor module 214 to examine the response content and determine the appropriate security policy to apply based on whether the response corresponds to static content known at build time or dynamic content generated at runtime.

In some embodiments, the interceptor module 214 is deployed as a sidecar process or sidecar container alongside the application 122. When deployed as a sidecar container, the interceptor module 214 runs in a separate container within the same deployment unit as the application container, with network traffic routed through the interceptor container before reaching the application container. When deployed as a sidecar process within the same container as the application 122, the interceptor module 214 runs as a separate process that can monitor file system changes for rendering mode artifacts and modify markup before requests are processed. The sidecar deployment model enables the interceptor module 214 to intercept all traffic to and from the application 122 without requiring modifications to the application code itself.

At block 404, processing logic obtains a cryptographic value representing the intercepted data. In some embodiments, interceptor module 214 computes a cryptographic hash of the response content received from the upstream application 122. The cryptographic hash serves as a fingerprint that uniquely identifies the response content, enabling efficient lookup in the CSP cache to determine whether the response corresponds to static content known at build time. The interceptor module 214 may compute the hash using the same cryptographic hash function that was used during the buildtime phase by application bundler module 212, such as SHA-256, SHA-384, or SHA-512, to ensure consistency between the hashes stored in the CSP cache and the hashes computed at runtime.

In some embodiments, obtaining the cryptographic value includes reading the response body content from the intercepted response, applying the configured hash algorithm to the content bytes, and encoding the resulting digest in a format suitable for comparison against entries in the CSP cache. The hash computation may be performed on the raw response content as received from the application 122, or may be performed on a normalized version of the content to account for variations in whitespace, encoding, or other formatting differences that do not affect the semantic content of the response. The cryptographic value may be computed incrementally as the response content is streamed from the application 122, enabling the interceptor module 214 to begin processing the response before the entire content has been received.

In some embodiments, the cryptographic value representing the intercepted data comprises a cryptographic hash of the content of the response to the request. For markup responses such as HTML documents, the hash is computed over the entire document content, including all elements, attributes, and text content. The hash value corresponds to the content hash field stored in CSP entries within the security manifest 252, enabling the interceptor module 214 to determine whether the response matches a known static document for which CSP values were pre-computed during buildtime. In additional or alternative embodiments, the cryptographic value may be derived from other characteristics of the request or response, such as the request path, query parameters, or response headers, depending on the caching strategy employed by the web-based application 122.

At block 406, processing logic determines, based on the obtained cryptographic value, whether the CSP cache stores a previously generated CSP value representing a CSP associated with an application resource pertaining to the request. In some embodiments, CSP cache module 216 performs a lookup operation using the cryptographic hash computed from the response content as a key to query the CSP cache within the security manifest 252. The lookup operation compares the computed hash against the content hash fields stored in CSP entries that were generated during the buildtime phase by application bundler module 212. A cache hit occurs when the computed hash matches a content hash stored in the CSP cache, indicating that the response corresponds to static content that was known at build time and for which CSP values were pre-computed. A cache miss occurs when no matching entry is found, indicating that the response corresponds to dynamic content generated at runtime or content that was not present during the buildtime phase.

In some embodiments, the determination involves accessing the CSP entries stored in the security manifest 252 and comparing the obtained cryptographic value against the content hash field of each CSP entry. The CSP cache may be organized as a hash table or similar data structure that enables constant-time or near-constant-time lookup based on the content hash, enabling efficient determination even when the security manifest contains a large number of entries. When a matching CSP entry is found, the interceptor module 214 retrieves the associated CSP hash entries, which include the directive to which each hash applies, the hash values themselves, and any flags such as whether strict-dynamic should be enabled for the response.

In some embodiments, the determination accounts for the relationship between documents and their subresources as recorded in the security manifest 252. When a cache hit is found for a document, the corresponding CSP entry includes not only the hashes for the document itself but also the descendant CSP hashes that authorize execution of all resources in the document's dependency tree. This enables the interceptor module 214 to construct a complete CSP header that authorizes the document and all of its dependencies without requiring additional lookups or runtime traversal of the dependency graph. The determination may also consider whether the response content type indicates markup content such as HTML that involves CSP enforcement, as opposed to other content types such as images or fonts that may not involve CSP headers.

Responsive to a determination that the CSP cache stores the previously generated CSP value associated with an application resource pertaining to the request, method 400 proceeds to block 408. At block 408, processing logic modifies a response to the request to include the CSP value. In some embodiments, response modifier module 220 constructs a CSP HTTP header using the CSP hash entries retrieved from the matching CSP entry in the security manifest 252. The CSP header specifies the security policy that the client browser should enforce when rendering the response content, including which scripts, stylesheets, and other resources are authorized to execute or load.

In some embodiments, constructing the CSP header involves aggregating the CSP hash entries associated with the matched document and formatting them according to the CSP directive syntax expected by browsers. For the script-src directive, the response modifier module 220 includes all script-related CSP hashes from the descendant CSP hashes array, enabling the browser to authorize execution of the document's scripts and all transitively referenced script dependencies. The header may include multiple hash values for the script-src directive, each formatted as an algorithm-prefixed base64-encoded digest such as ‘sha256-[base64-encoded-hash]’. Similarly, for the style-src directive, the response modifier module 220 includes CSP hashes corresponding to stylesheets referenced by the document.

In some embodiments, the response modifier module 220 includes the ‘strict-dynamic’ keyword in the script-src directive when the CSP entry indicates that strict-dynamic should be enabled. The strict-dynamic keyword instructs the browser to propagate trust to scripts that are dynamically loaded by already-trusted scripts, enabling hash-based CSP to work with modern JavaScript patterns that involve dynamic script loading. When strict-dynamic is enabled, the browser allows scripts authorized by hash or nonce to load additional scripts without those additional scripts being explicitly listed in the CSP, provided the loading is performed through trusted mechanisms.

In some embodiments, modifying the response includes injecting or updating subresource integrity attributes in the response markup. For responses that contain HTML documents, the response modifier module 220 may parse the response content to identify script and link elements that reference external resources and inject integrity attributes containing the pre-computed subresource integrity digests from the security manifest 252. This injection ensures that even if the markup served by the application 122 does not include integrity attributes, the modified response delivered to the client device 102 includes the integrity verification information needed for the browser to validate fetched resources.

In some embodiments, the response modifier module 220 adds additional CSP directives beyond script-src and style-src to provide comprehensive security policy coverage. These additional directives may include base-uri to restrict the URLs that can be used in the document's base element, form-action to restrict the URLs to which forms can be submitted, frame-ancestors to restrict which origins can embed the document in frames, object-src to restrict the sources for plugins, and default-src to provide a fallback policy for directives not explicitly specified. The specific directives and their values may be configured during the buildtime phase and stored in the security manifest 252 for application at runtime.

In some embodiments, the response modifier module 220 includes reporting directives in the CSP header to enable monitoring of policy violations. The report-uri or report-to directive specifies an endpoint to which the browser should send reports when the CSP is violated, enabling administrators to detect attempted attacks or misconfigurations that cause legitimate resources to be blocked. The ‘report-sample’ keyword may be included in relevant directives to instruct the browser to include a sample of the violating content in violation reports, aiding in diagnosis of policy issues.

At block 410, processing logic forwards the modified response to a client device associated with the request. In some embodiments, interceptor module 214 transmits the modified response over network 104 to the client device 102 that originated the request. The modified response includes the CSP HTTP header constructed by response modifier module 220, along with any injected subresource integrity attributes and other security-related modifications applied during the response modification process at block 408. The client device 102 receives the modified response and the browser executing on the client device 102 parses the CSP header to establish the security policy that will govern resource loading and script execution for the received document.

In some embodiments, forwarding the modified response includes transmitting additional HTTP headers that complement the CSP header. These additional headers may include a CSP-Report-Only header that specifies a reporting-only policy for monitoring purposes without enforcement, enabling administrators to test new policies before deploying them in enforcement mode. The response may also include headers related to other security mechanisms, such as X-Content-Type-Options to prevent MIME type sniffing, X-Frame-Options to control framing behavior, and Strict-Transport-Security to enforce secure connections.

In some embodiments, the interceptor module 214 logs information about the forwarded response for monitoring and auditing purposes. The logged information may include the request path, the content hash of the response, whether the CSP cache lookup resulted in a hit or miss, the CSP directives included in the response, and timing information indicating the latency introduced by the security policy application process. This logging enables administrators to monitor the effectiveness of the hybrid CSP enforcement system and identify potential issues such as unexpected cache misses or policy violations.

In some embodiments, the browser on the client device 102 enforces the CSP received in the modified response by evaluating each resource load and script execution against the policy directives. When the browser attempts to execute a script, it computes the hash of the script content and compares the computed hash against the hashes specified in the script-src directive of the CSP. If the computed hash matches one of the authorized hashes, the browser permits the script to execute; otherwise, the browser blocks the script execution and may report a violation to the endpoint specified in the report-uri or report-to directive. Similarly, when the browser fetches a resource with a subresource integrity attribute, it verifies that the fetched content matches the expected hash before using the resource, providing an additional layer of protection against tampering or supply chain attacks.

Referring back to block 406, responsive to a determination that the CSP cache does not store the previously generated CSP value associated with an application resource pertaining to the request, method 400 proceeds to block 412. At block 412, processing logic generates a request token that is valid during a lifetime of the request. In some embodiments, token generator module 218 generates a nonce (number used once) that serves as a cryptographic random value unique to the current request. The nonce is a token that is generated fresh for each request and is used to authorize execution of dynamically generated scripts and styles that were not known at build time and therefore do not have pre-computed hash values stored in the CSP cache.

In some embodiments, the token generator module 218 generates the request token using a cryptographically secure random number generator to produce a value with sufficient entropy to prevent prediction or collision attacks. The generated nonce may be encoded in base64 format to produce a string suitable for inclusion in HTTP headers and HTML attributes. The nonce value is valid only for the duration of the single request-response cycle, meaning that subsequent requests receive different nonce values even if they request the same resource. This per-request uniqueness ensures that an attacker who observes a nonce value from one response cannot reuse that nonce to authorize malicious scripts in subsequent requests.

In some embodiments, the request token is used to construct a nonce-based CSP directive that authorizes scripts and styles containing the matching nonce attribute. When the interceptor module 214 determines that a response corresponds to dynamic content not found in the CSP cache, the token generator module 218 generates a nonce, and the response modifier module 220 includes the nonce in the CSP header using the format ‘nonce-[base64-encoded-value]’ within the script-src and style-src directives. The response modifier module 220 also injects the nonce attribute into script and style elements within the response markup, enabling the browser to match the nonce in the CSP header against the nonce attributes in the markup and authorize execution of the corresponding scripts and styles.

In some embodiments, the use of nonce-based authorization for dynamic content represents the runtime component of the hybrid CSP enforcement approach. While static content benefits from hash-based CSP that enables caching, dynamic content that varies between requests cannot be pre-hashed and therefore relies on nonce-based authorization. The nonce-based approach ensures that dynamically rendered content receives appropriate security policy protection even though the specific content was not known during the buildtime phase. However, as each request receives a unique nonce, responses containing nonce-based CSP cannot be cached by the browser or intermediate caching proxies, as the nonce value in a cached response would not match the nonce expected by subsequent requests.

At block 414, processing logic obtains integrity data associated with each application resource. Although the response content itself was not known at build time and therefore does not have a matching CSP entry in the cache, the individual resources referenced by the dynamic response may correspond to static assets that were processed during the buildtime phase and for which integrity data was pre-computed and stored in the security manifest 252.

In some embodiments, obtaining the integrity data includes parsing the response content to identify references to external resources, such as script elements with src attributes, link elements referencing stylesheets, and image elements referencing image files. For each identified resource reference, the interceptor module 214 queries the security manifest 252 using the resource URL or path to retrieve the corresponding entry containing the pre-computed subresource integrity digest. The integrity data retrieved from the manifest includes the algorithm used for hashing, the base64-encoded digest value, and the complete subresource integrity string formatted for injection into the markup.

In some embodiments, the interceptor module 214 maintains an index or lookup table derived from the security manifest 252 that maps resource URLs and paths to their corresponding integrity data entries, enabling efficient retrieval without requiring a full scan of the manifest for each resource reference. The lookup may account for URL normalization to handle variations in path formatting, query parameters, or URL encoding that could cause mismatches between the URLs in the response markup and the paths stored in the manifest.

In some embodiments, when a referenced resource is not found in the security manifest 252, the interceptor module 214 may compute the integrity digest at runtime by fetching the resource content and applying the configured hash algorithm. This runtime computation enables integrity protection for resources that were not present during the buildtime phase, such as resources added after deployment or resources served from external sources that were not fetched during the build process. However, runtime integrity computation introduces additional latency and does not provide the same level of supply chain attack protection as buildtime computation, since the resource content being hashed may already have been compromised.

In some embodiments, the obtained integrity data includes subresource integrity digests for various types of resources including JavaScript files, JavaScript modules, CSS stylesheets, fonts, and images. The integrity data enables the browser to verify that fetched resources match the expected content, providing protection against tampering or man-in-the-middle attacks that could modify resources in transit. By obtaining and injecting integrity data for resources referenced by dynamic responses, the hybrid CSP enforcement system extends subresource integrity protection to dynamically rendered content that would otherwise lack integrity verification.

At block 416, processing logic modifies a response to the request to include the generated request token and/or the obtained integrity data. In some embodiments, response modifier module 220 constructs a CSP HTTP header that includes the nonce generated by token generator module 218 at block 412. The nonce is included in the script-src directive using the format ‘nonce-[base64-encoded-value]’, which instructs the browser to authorize execution of scripts that contain a matching nonce attribute. Similarly, the nonce may be included in the style-src directive to authorize dynamically generated stylesheets that contain the matching nonce attribute.

In some embodiments, the response modifier module 220 parses the response content to identify script and style elements that involve nonce injection. For each inline script element in the response markup, the response modifier module 220 adds a nonce attribute containing the generated request token value, enabling the browser to match the nonce in the element against the nonce specified in the CSP header and authorize execution of the script. Similarly, for each inline style element, the response modifier module 220 injects the nonce attribute to enable the browser to authorize application of the styles. This injection process ensures that dynamically generated inline content receives appropriate authorization through the nonce-based CSP mechanism.

In some embodiments, the response modifier module 220 injects subresource integrity attributes into the response markup using the integrity data obtained at block 414. For each script element with a src attribute that references a resource for which integrity data was retrieved from the security manifest 252, the response modifier module 220 adds an integrity attribute containing the subresource integrity string and a crossorigin attribute set to an appropriate value such as “anonymous” to enable integrity checking for cross-origin resources. Similarly, for each link element referencing a stylesheet or other resource type that supports integrity checking, the response modifier module 220 injects the corresponding integrity attribute. This injection ensures that even dynamically generated markup includes integrity verification for referenced static resources, enabling the browser to detect tampering or supply chain attacks that modify resources in transit.

In some embodiments, the response modifier module 220 includes the ‘strict-dynamic’ keyword in the script-src directive when modifying responses for dynamic content. The strict-dynamic keyword enables scripts authorized by the nonce to dynamically load additional scripts without requiring those additional scripts to be explicitly listed in the CSP. This capability is important for modern JavaScript applications that use dynamic module loading or lazy loading patterns, where the specific scripts to be loaded may not be known until runtime. When strict-dynamic is enabled, the browser propagates trust from nonce-authorized scripts to scripts they load through trusted mechanisms such as createElement and appendChild.

In some embodiments, the response modifier module 220 includes additional CSP directives in the header to provide comprehensive security policy coverage for dynamic responses. These directives may include ‘unsafe-inline’ as a fallback for browsers that do not support nonce-based CSP, although the presence of a nonce causes modern browsers to ignore the ‘unsafe-inline’ keyword and enforce the stricter nonce-based policy. The response modifier module 220 may also include directives such as base-uri, form-action, frame-ancestors, and object-src with appropriate values to restrict other potential attack vectors beyond script injection.

In some embodiments, the response modifier module 220 includes reporting directives in the CSP header to enable monitoring of policy violations for dynamic responses. The report-uri or report-to directive specifies an endpoint to which the browser should send violation reports, enabling administrators to detect attempted attacks or identify legitimate resources that are being incorrectly blocked by the policy. Monitoring violation reports for dynamic responses can help identify cases where the nonce injection process failed to cover all inline scripts or where referenced resources lack integrity data in the security manifest.

Responsive to modifying the response to the request to include the generated request token and/or the obtained integrity data in accordance with block 416, method 400 can proceed to block 410, where processing logic forwards the modified response to the client device associated with the request. In some embodiments, interceptor module 214 transmits the modified response over network 104 to the client device 102 that originated the request. The modified response includes the CSP HTTP header containing the nonce-based directives constructed by response modifier module 220, along with the injected nonce attributes in inline script and style elements and the injected integrity attributes for referenced resources. The client device 102 receives the modified response and the browser executing on the client device 102 parses the CSP header to establish the security policy governing resource loading and script execution for the received document.

In some embodiments, the browser on the client device 102 enforces the nonce-based CSP by comparing the nonce attribute of each inline script and style element against the nonce value specified in the corresponding CSP directive. When the browser encounters an inline script element, it extracts the nonce attribute value and compares it against the nonces listed in the script-src directive. If a match is found, the browser permits the script to execute; otherwise, the browser blocks the script execution and may report a violation. This enforcement mechanism ensures that only scripts containing the request-specific nonce generated by the interceptor module 214 are authorized to execute, preventing injection of malicious scripts by attackers who do not have access to the nonce value.

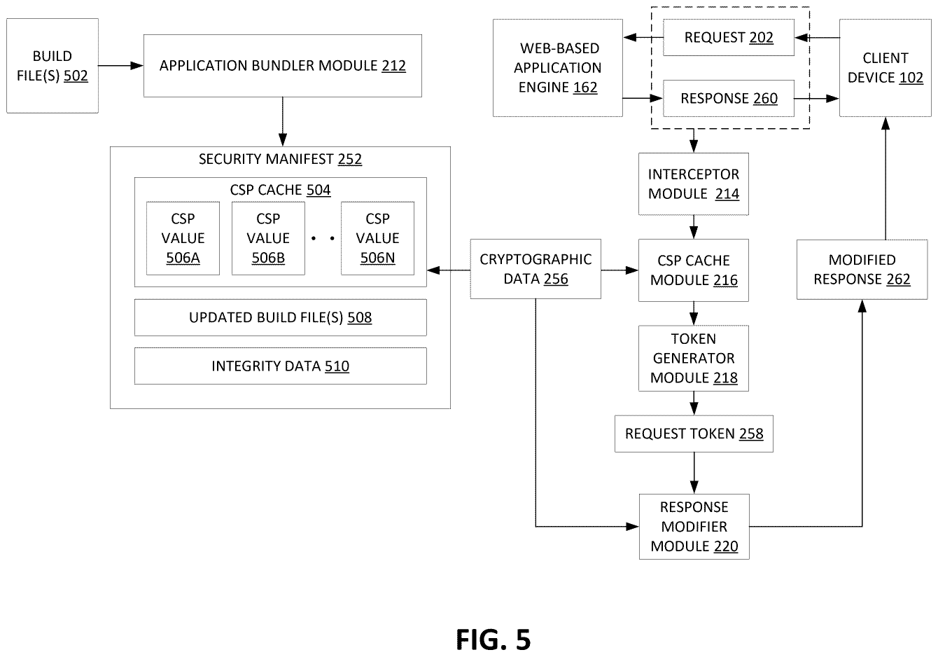

FIG. 5 depicts an example of hybrid content security policy enforcement for a web-based application, in accordance with implementations of the present disclosure. As illustrated in FIG. 5, the system includes an application bundler module 212 that receives build files 502 associated with a web-based application during a buildtime phase. The application bundler module 212 processes the build files 502 to generate a security manifest 252, which includes a CSP cache 504 storing pre-computed CSP values 506A, 506B, and 506N corresponding to resources of the web-based application. The security manifest 252 also includes updated build files 508 that have been modified to include integrity data 510, such as subresource integrity digests injected into markup elements.

During runtime, a client device 102 sends a request 202 to the web-based application engine 162. The interceptor module 214 intercepts traffic associated with the request 202 and receives a response 260 from the upstream application. The interceptor module 214 obtains cryptographic data 256, such as a cryptographic hash of the response content, and provides this data to the CSP cache module 216. The CSP cache module 216 queries the CSP cache 504 within the security manifest 252 to determine whether a previously generated CSP value exists for the response content.

When the cryptographic data 256 matches an entry in the CSP cache 504, indicating a cache hit for static content, the CSP cache module 216 retrieves the corresponding pre-computed CSP value (e.g., CSP value 506A) and provides it to the response modifier module 220. When no match is found in the CSP cache 504, indicating dynamic content or content not known at build time, the token generator module 218 generates a request token 258, such as a nonce that is valid during the lifetime of the request. The response modifier module 220 receives either the cached CSP value or the generated request token 258 and produces a modified response 262 that includes the appropriate content security policy information. The modified response 262 is then forwarded to the client device 102, enabling the browser to enforce the security policy by authorizing execution of scripts and styles that match the hash values or nonce specified in the CSP header.

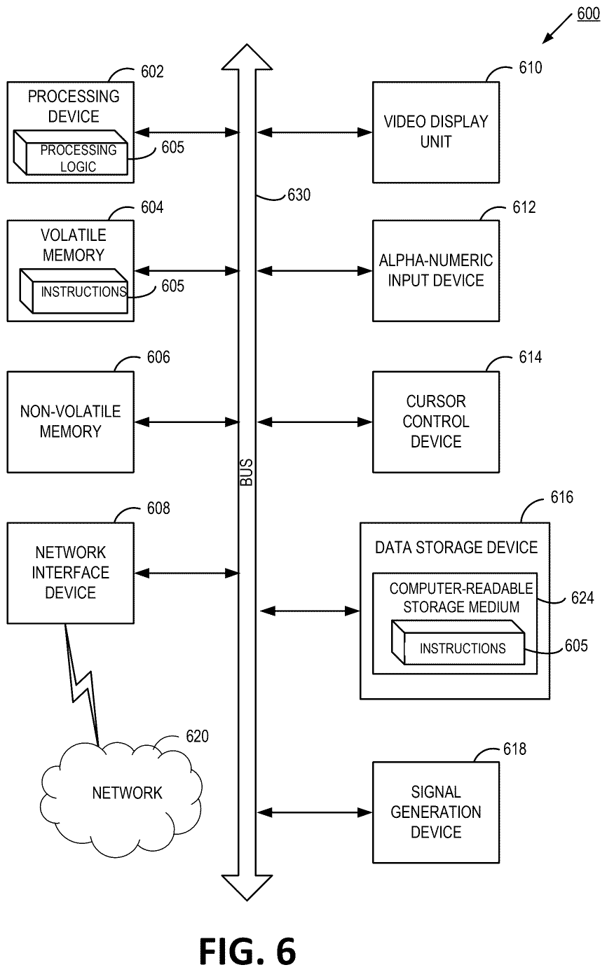

FIG. 6 is a block diagram illustrating an exemplary computer system 600, in accordance with implementations of the present disclosure. The computer system 600 can correspond to platform 120, server machine 150, node(s) 160, predictive system 180, and/or client devices 102A-N, described with respect to FIG. 1. Computer system 600 can operate in the capacity of a server or an endpoint machine in endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 600 includes a processing device (processor) 602, a main memory 604 (e.g., read-only memory (ROM), flash memory, dynamic random access memory (DRAM) such as synchronous DRAM (SDRAM), double data rate (DDR SDRAM), or DRAM (RDRAM), etc.), a static memory 606 (e.g., flash memory, static random access memory (SRAM), etc.), and a data storage device 616, which communicate with each other via a bus 630.

Processor (processing device) 602 represents one or more general-purpose processing devices such as a microprocessor, central processing unit, or the like. More particularly, the processor 602 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 602 can also be one or more special-purpose processing devices such as an application specific integrated circuit (ASIC), a field programmable gate array (FPGA), a digital signal processor (DSP), network processor, or the like. The processor 602 is configured to execute instructions 605 (e.g., improving precision of content matching systems at a platform) for performing the operations discussed herein.

The computer system 600 can further include a network interface device 608. The computer system 600 also can include a video display unit 610 (e.g., a liquid crystal display (LCD) or a cathode ray tube (CRT)), an input device 612 (e.g., a keyboard, and alphanumeric keyboard, a motion sensing input device, touch screen), a cursor control device 614 (e.g., a mouse), and a signal generation device 618 (e.g., a speaker).

The data storage device 616 can include a non-transitory machine-readable storage medium 624 (also computer-readable storage medium) on which is stored one or more sets of instructions 605 (e.g., improving precision of content matching systems at a platform) embodying any one or more of the methodologies or functions described herein. The instructions can also reside, completely or at least partially, within the main memory 604 and/or within the processor 602 during execution thereof by the computer system 600, the main memory 604 and the processor 602 also constituting machine-readable storage media. The instructions can further be transmitted or received over a network 620 via the network interface device 608.

In one implementation, the instructions 605 include instructions for providing fine-grained version histories of electronic documents at a platform. While the computer-readable storage medium 624 (machine-readable storage medium) is shown in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

Reference throughout this specification to “one implementation,” “one embodiment,” “an implementation,” or “an embodiment,” means that a particular feature, structure, or characteristic described in connection with the implementation and/or embodiment is included in at least one implementation and/or embodiment. Thus, the appearances of the phrase “in one implementation,” or “in an implementation,” in various places throughout this specification can, but are not necessarily, referring to the same implementation, depending on the circumstances. Furthermore, the particular features, structures, or characteristics can be combined in any suitable manner in one or more implementations.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component can be, but is not limited to being, a process running on a processor (e.g., digital signal processor), a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. Further, a “device” can come in the form of specially designed hardware; generalized hardware made specialized by the execution of software thereon that enables hardware to perform specific functions (e.g., generating interest points and/or descriptors); software on a computer readable medium; or a combination thereof.

The aforementioned systems, circuits, modules, and so on have been described with respect to interact between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Finally, implementations described herein include collection of data describing a user and/or activities of a user. In one implementation, such data is only collected upon the user providing consent to the collection of this data. In some implementations, a user is prompted to explicitly allow data collection. Further, the user can opt-in or opt-out of participating in such data collection activities. In one implementation, the collect data is anonymized prior to performing any analysis to obtain any statistical patterns so that the identity of the user cannot be determined from the collected data.

What is claimed is:

1. A method comprising:
intercepting data associated with a request directed to a web-based application;
obtaining a cryptographic value representing the intercepted data;
determining, based on the obtained cryptographic value, whether a content security policy (CSP) cache associated with the web-based application stores a previously generated CSP value representing a CSP associated with an application resource pertaining to the request;
responsive to determining that the CSP cache stores the previously generated CSP value, modifying a response to the request to include the previously generated CSP value; and
forwarding the modified response to a client device associated with the request.

2. The method of claim 1, further comprising:
responsive to determining that the CSP cache does not store the previously generated CSP value, generating a request token that is valid during a lifetime of the request; and
modifying the response to the request to include the generated request token.

3. The method of claim 2, further comprising:
identifying one or more application resources pertaining to the request; and
modifying the response to further include integrity data associated with each of the one or more identified application resources.

4. The method of claim 2, further comprising:
parsing the modified response to identify malicious data; and
responsive to identifying the malicious data based on the parsing, performing one or more operations to remove the malicious data from the modified response.

5. The method of claim 1, further comprising:
identifying one or more build files associated with the web-based application;
determining one or more application resources associated with the web-based application based on the identified one or more build files;
generating, for each respective application resource of the determined one or more application resources, at least one CSP value representing the CSP corresponding to the respective application resource; and
updating the CSP cache to store the generated at least one CSP value, wherein updated CSP cache comprises the previously generated CSP value representing the CSP associated with the application resource pertaining to the request.

6. The method of claim 5, further comprising:
generating integrity data for each of the determined one or more application resources associated with the web-based application, the integrity data indicating an initial state of the determined one or more application resources during a build time associated with the web-based application; and
updating the identified one or more build files to include the generated integrity data.

7. The method of claim 6, further comprising:
identifying, based on the generated integrity data, at least one application resource of the one or more application resources that satisfies a security threat criterion; and
performing one or more threat neutralization operations to neutralize a security threat associated with the at least one application resource,
wherein the identified one or more build files are updated based on an output of the one or more threat neutralization operations.

8. The method of claim 6, wherein the determined one or more application resources associated with the web-based application comprise at least one third-party resource.

9. The method of claim 1, wherein the CSP cache is comprised in an immutable security manifest generated during a build time of the web-based application, the immutable security manifest further comprising metadata associated with one or more build files associated with the web-based application and integrity data generated for one or more application resources associated with the web-based application.

10. The method of claim 1, wherein the cryptographic value representing the intercepted data comprises a cryptographic hash of at least one of content of the request or content of the response to the request.

11. A system comprising:
a memory; and
a processing device coupled to the memory, the processing device to perform operations comprising:
intercepting data associated with a request directed to a web-based application;
obtaining a cryptographic value representing the intercepted data;
determining, based on the obtained cryptographic value, whether a content security policy (CSP) cache associated with the web-based application stores a previously generated CSP value representing a CSP associated with an application resource pertaining to the request;
responsive to determining that the CSP cache stores the previously generated CSP value, modifying a response to the request to include the previously generated CSP value; and
forwarding the modified response to a client device associated with the request.

12. The system of claim 11, wherein the operations further comprise:
responsive to determining that the CSP cache does not store the previously generated CSP value, generating a request token that is valid during a lifetime of the request; and
modifying the response to the request to include the generated request token.

13. The system of claim 12, wherein the operations further comprise:
identifying one or more application resources pertaining to the request; and
modifying the response to further include integrity data associated with each of the one or more identified application resources.

14. The system of claim 12, wherein the operations further comprise:
parsing the modified response to identify malicious data; and
responsive to identifying the malicious data based on the parsing, performing one or more operations to remove the malicious data from the modified response.

15. The system of claim 11, wherein the operations further comprise:
identifying one or more build files associated with the web-based application;
determining one or more application resources associated with the web-based application based on the identified one or more build files;
generating, for each respective application resource of the determined one or more application resources, at least one CSP value representing the CSP corresponding to the respective application resource; and
updating the CSP cache to store the generated at least one CSP value, wherein updated CSP cache comprises the previously generated CSP value representing the CSP associated with the application resource pertaining to the request.

16. The system of claim 15, wherein the operations further comprise:
generating integrity data for each of the determined one or more application resources associated with the web-based application, the integrity data indicating an initial state of the determined one or more application resources during a build time associated with the web-based application; and
updating the identified one or more build files to include the generated integrity data.

17. The system of claim 16, wherein the operations further comprise:
identifying, based on the generated integrity data, at least one application resource of the one or more application resources that satisfies a security threat criterion; and
performing one or more threat neutralization operations to neutralize a security threat associated with the at least one application resource,
wherein the identified one or more build files are updated based on an output of the one or more threat neutralization operations.

18. The system of claim 16, wherein the determined one or more application resources associated with the web-based application comprise at least one third-party resource.

19. The system of claim 11, wherein the CSP cache is comprised in an immutable security manifest generated during a build time of the web-based application, the immutable security manifest further comprising metadata associated with one or more build files associated with the web-based application and integrity data generated for one or more application resources associated with the web-based application.

20. A non-transitory computer readable storage medium comprising instructions for a server that, when executed by a processing device, cause the processing device to perform operations comprising:
intercepting data associated with a request directed to a web-based application;
obtaining a cryptographic value representing the intercepted data;
determining, based on the obtained cryptographic value, whether a content security policy (CSP) cache associated with the web-based application stores a previously generated CSP value representing a CSP associated with an application resource pertaining to the request;
responsive to determining that the CSP cache stores the previously generated CSP value, modifying a response to the request to include the previously generated CSP value; and
forwarding the modified response to a client device associated with the request.
